(19) United States
(12) Patent Application Publication
(10) Pub. No.: US 2007/0139319 A1
(43) Pub. Date: Jun. 21, 2007

(54) Image display apparatus

(75) Inventors: Tsutomu Nishida, Yokohama (JP); Sachiyo Yamada, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/607,878

(22) Filed: Dec. 4, 2006

(30) Foreign Application Priority Data
Dec. 21, 2005 (JP) 2005-368039
Sep. 27, 2006 (KR) 10-2006-0094336

(51) Int. Cl. G09G 3/32

(52) U.S. Cl. 345/83

(57) ABSTRACT

An image display apparatus includes a light source unit including light emitting elements halving different wavelengths, wherein n (n is an integer higher that 2) light emitting elements have at least one wavelength; and a light-up controller which drives the light emitting elements having different wavelengths in a time-sequential manner within a time period, wherein the light-up controller divides the n light emitting elements having at least one wavelength into m (m is an integer satisfying 2≦m≦n) light-up groups having a same light-up timing, and the m light-up groups are alternately lighted at a frequency of 1/m within the time period, so that any one of the m light-up groups can be lighted within the time period.

### CROSS-REFERENCE TO RELATED PATENT APPLICATION

This application claims priority from Japanese Patent Application No. 10-2005-0368039, filed on Dec. 21, 2005 in the Japanese Intellectual Property Office, and Korean Patent Application No. 10-2006-0094336, filed on Sep. 27, 2006 in the Korean Intellectual Property Office, the disclosures of which are incorporated herein in their entirety by reference.

### BACKGROUND OF THE INVENTION

1 . Field of the Invention

The present invention relates to an image display apparatus employing as a light source a plurality of light emitting elements having different wavelengths.

2. Description of the Related Art

Examples of a related art image display apparatus for enlarging and projecting an image onto a reflective or transmissive screen include a projector and a rear projection television set. In the related art image display apparatus, images decomposed into red R, green G, and blue B color components are sequentially displayed, thereby displaying a full color image.

When a light emitting element such as a light emitting diode (LED) is used, since a light source with high brightness is required for enlargement and projection, the related art image display apparatus usually employs a plurality of light emitting elements and lights the plurality of light emitting elements for each light emitting wavelength substantially simultaneously.

FIG. 1 illustrates an example of a timing chart of a driving signal when two LEDs are used for each color component in the related art image display apparatus. Reference numerals 200 and 201 denote driving signals of LEDs R1 and R2 having a wavelength R. Reference numerals 202 and 203 denote driving signals of LEDs G1 and G2 having a wavelength G. Reference numerals 204 and 205 denote driving signals of LEDs B1 and B2 having a wavelength B. Each driving signal has a square waveform with a light-up frequency equal to a constant frequency of f0=1/T0. The driving signals have light-up duties tR/T0, tG/T0, tB/T0 with respect to the R, G, and B color components, respectively. The LEDs with R, G, and B wavelengths for the respective driving signals are driven in a time-sequential manner. In this case, tR, tG, and tB are properly set in the range satisfying the relation of tR+tG+tB=T0. In addition, amplitudes of the respective driving signals are equal to the magnitudes IR, IG, IB according to required driving currents.

As a technique related to a light-up control of a plurality of LEDs, Japanese Patent Laid-open Publication No. 2002-319707, the contents of which is incorporated herein by reference, discloses an LED driving circuit in which at least two LEDs are provided so as to reduce the power consumption for each LED and which can drive the LEDs without causing brightness degradation caused by the decrease in total light intensity when at least one of the LEDs is periodically transited between on and off positions.

The image display apparatus using a light emitting element such as the related art LED has at least the following problems.

A light source with high brightness can be constructed such that a plurality of LEDs are simultaneously lighted. However, when a multi-chip LED light source unit is used to make a small sized device, the plurality of LED chips are adjacent to one another, and thus, the temperature increases during the light-up time. As a result, the lifespan of the LEDs may be reduced or the brightness thereof may be degraded.

Although a device for periodically switching on and off a plurality of LEDs is described in the aforementioned related art Japanese Patent Laid-open Publication No. 2002-319707, the device is used only to reduce the power consumption, and no device and method for periodically transiting on and off a plurality of LEDs to avoid brightness degradation caused by self heat generation of LEDs have been yet presented. Therefore, even if this LED driving circuit is used in the image display apparatus, there has been no immediate solution for the above mentioned related art problems.

### SUMMARY OF THE INVENTION

The present invention provides an image display apparatus in which a temperature increase caused by self heat generation of a light emitting element is substantially restricted when an image is displayed by projecting light onto a screen through a sequential light-up operation of a plurality of light emitting elements. In addition, the lifespan of the light emitting element may be substantially increased, and brightness degradation caused by thermal influence may be reduced.

According to an aspect of the present invention, there is provided an image display apparatus comprising: a light source unit which includes a plurality of light emitting elements having different wavelengths, wherein n (n is an integer higher than 2) light emitting elements have at least one wavelength; and a light-up controller which drives the light emitting elements having different wavelengths in a time-sequential manner within a time period, wherein the light-up controller divides the n light emitting elements having at least one wavelength into m (m is an integer satisfying 2≦m≦n) light-up groups having a same light-up timing, and the m light-up groups are alternately lighten up at a frequency of 1/m within the time period, so that any one of the m light-up groups can be lighten up within the time period.

Since the light-up controller divides the n light emitting elements having at least one wavelength into m light-up groups having the same light-up timing, and the m light-up groups are alternately lighted up at a frequency of 1/m within the time period, it may be possible to substantially reduce a temperature increase of the light emitting elements.

### BRIEF DESCRIPTION OF THE DRAWINGS

The above and other aspects will become more apparent by describing in detail exemplary embodiments thereof with reference to the attached drawings in which:

FIG. 1 is a timing chart illustrating a driving signal of a light source unit, wherein the driving signal is generated by a light-up controller of a related art image display apparatus;

FIG. 2 is a schematic view illustrating a configuration of an image display apparatus according to an exemplary embodiment of the present invention;

FIG. 3 is a block diagram illustrating a configuration of a light source unit and a light controller used in the image display apparatus of FIG. 1, according to an exemplary embodiment of the present invention;

FIG. 4 is a timing chart illustrating a driving signal of a light source unit, wherein the driving signal is generated by a light controller of the image display apparatus of FIG. 1, according to an exemplary embodiment of the present invention;

FIG. 5 is a graph illustrating a light output of an LED according to temperature, wherein the horizontal axis denotes time and the vertical axis denotes a relative value of light output;

FIG. 6 is a timing chart illustrating a driving signal of a light source unit, wherein the driving signal is generated by a light controller of an image display apparatus, according to another exemplary embodiment of the present invention; and

FIG. 7 is a graph illustrating brightness changes during the operation of the image display apparatus described with respect to FIG. 6, according to another exemplary embodiment of the present invention.

### DETAILED DESCRIPTION OF THE EXEMPLARY EMBODIMENTS

Hereinafter, exemplary embodiments will be described with reference to the accompanying drawings. Like reference numerals denote like or similar elements throughout the drawings.

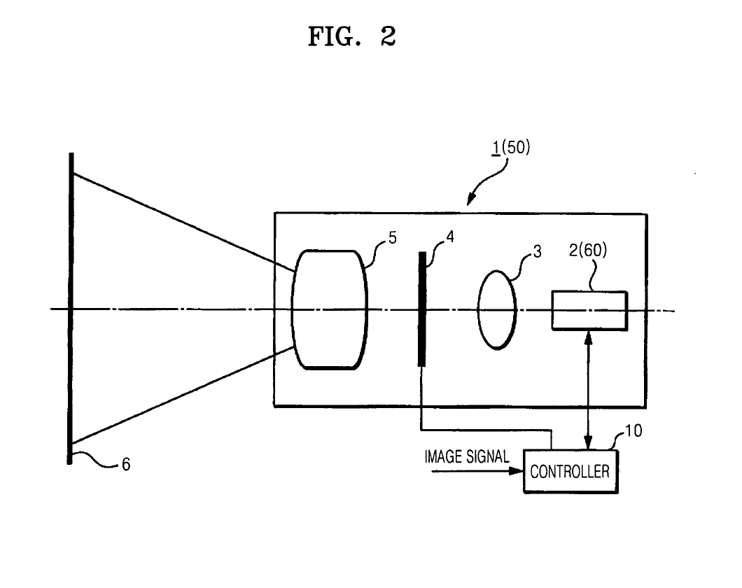

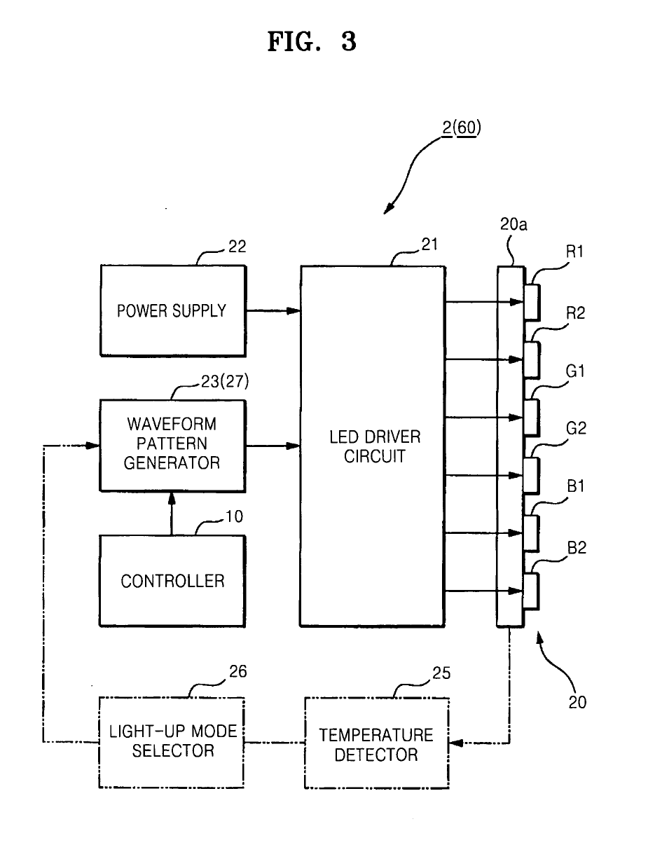

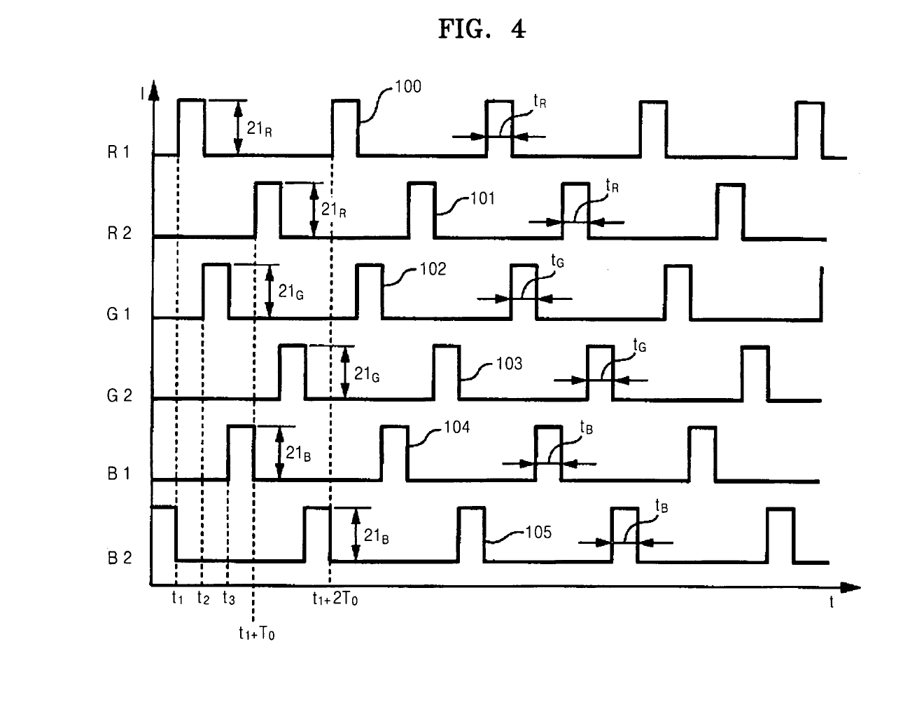

FIG. 2 is a schematic view illustrating a configuration of an image display apparatus 1 according to an exemplary embodiment of the present invention. FIG. 3 is a block diagram illustrating a configuration of a light source unit and a light controller used in the image display apparatus 1, according to an exemplary embodiment of the present invention. FIG. 4 is a timing chart illustrating a driving signal of a light source unit, wherein the driving signal is generated by a light controller of the image display apparatus 1, according to an exemplary embodiment of the present invention.

The image display apparatus 1 is a projector which projects a full color image onto a reflective screen 6 in response to an external signal. The image display apparatus 1 includes an illumination unit 2, a condenser lens 3, a spatial modulator 4, a projection lens 5, and a controller 10. The controller 10 controls the image display apparatus 1.

To display the full color image, the illumination unit 2 sequentially generates light beams corresponding to respective wavelengths of three primary colors R, G, and B in a time-sequential manner.

The condenser lens 3 is an optical element which condenses light generated by the illumination unit 2 onto a modulation area of the spatial modulator 4. The spatial modulator 4 spatially modulates the light condensed by the condenser lens 3 in response to a light image signal having a wavelength corresponding to an illumination timing, thereby displaying a color-decomposed image. The spatial modulator 4 may be a transmissive element or a reflective element. For example but not by way of limitation, the transmissive element may be a liquid crystal device (LCD). Further, the reflective device may be a digital micro-mirror device (DMD), that is, a micro mirror array, or a reflective liquid crystal panel, that is, a panel having a liquid crystal on silicon (LCOS).

The projection lens 5 is an optical element which enlarges and projects the image displayed through the spatial modulator 4 onto the reflective screen 6.

As indicated by a solid line in FIG. 3, the illumination unit 2 includes a light emitting diode (LED) light source unit 20, an LED driver circuit 21, a power supply unit 22, and a waveform pattern generator 23.

The LED light source unit 20 is a light emitting element in which first and second red LEDs R1 and R2, first and second green LEDs G1 and G2, and first and second blue LEDs B1 and B2, each illuminating light having wavelengths of the three primary colors R, G, and B, are disposed on a base member 20a. The LEDs R1, R2, G1, G2, B1, and B2 are only examples of the light emitting element that emits monochrome light, and the present invention is not limited thereto. For example but not by way of limitation, the light emitting element may be an organic light emitting diode (OLED). The LEDs R1, R2, G1, G2, B1, and B2 may be placed on the base member 20a in the form of an unpackaged chip to achieve a substantially small sized device.

FIG. 2 is only a schematic view, and the elements may be differently disposed. In the present exemplary embodiment, each LED is two-dimensionally disposed on the base member 20a so that light emitted from the condenser lens 3 may be easily condensed.

The base member 20a also serves as a heat-dissipation member of each LED. At least the vicinities of each LED in the base member 20a are under the influence of temperature changes of each LED.

The LED driver circuit 21 controls a driving current supplied from the power supply 22 in response to driving signals of the LEDs R1, R2, G1, G2, B1, and B2 transmitted from the waveform pattern generator 23, and separately drives each of the LEDs R1, R2, G1, G2, B1, and B2.

According to control information, such as a light-up clock signal supplied from the controller 10, light-up duties of R, G, and B color components, and an amplitude, the waveform pattern generator 23 modulates a pulse width of the light-up clock signal or performs an arithmetic operation on a delayed signal. Further, the waveform pattern generator 23 generates a driving signal having a specific waveform pattern in synchronization with the light-up clock signal, and selects an LED to be lighted up.

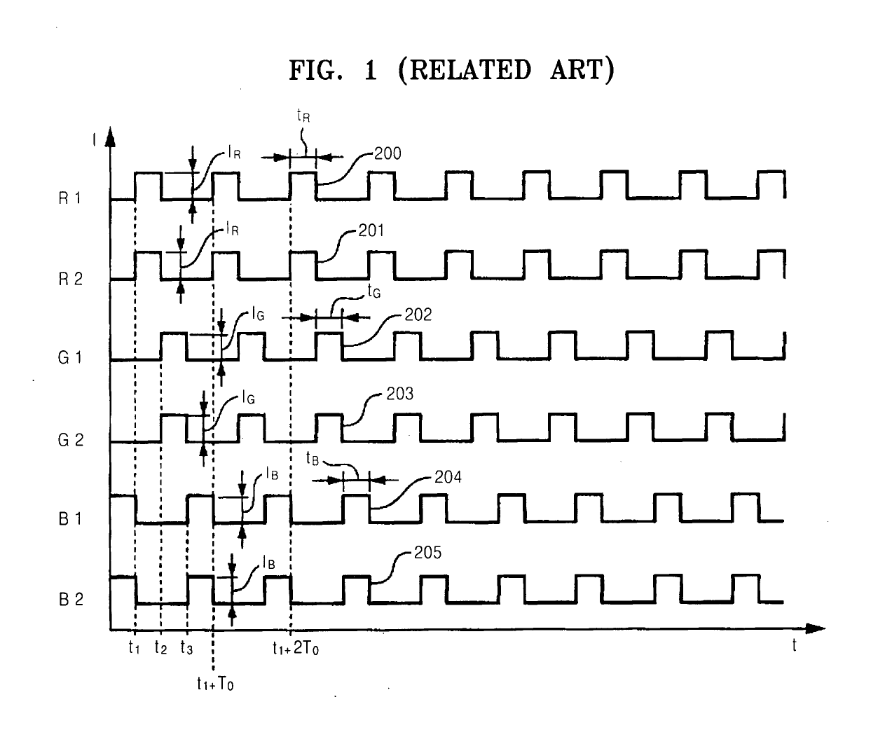

In the present exemplary embodiment, a driving signal is generated with a waveform pattern as illustrated in FIG. 4. For comparison with the related art method, a basic light-up frequency f₀=1/T₀ of the light-up clock signal and light-up duties t_{R}/T₀, t_{G}/T₀, and t_{B}/T₀ (here, t_{R}+t_{G}+t_{B}=T₀) of each color component are set to be substantially the same as those illustrated in FIG. 1. For example, according to the brightness feature of each color, the light-up duties of each color may be set to be t_{R}/T₀=20%, t_{G}/T₀=40%, and t_{B}/T₀=40%.

A signal 100 for driving the first red LED R1 is a pulse signal which initiates a light-up operation at a time t1 and has a frequency of f=f₀/2, an amplitude of 2·I_{R}, and a light-up duty of t_{R}/(2·T₀). A signal 102 for driving the first green LED G1 is a pulse signal which initiates a light-up operation at a time t₂=t₁+t_{R} and has a frequency of f=f₀/2, an amplitude of 2·I_{G}, and a light-up duty of t_{G}/(2·T₀). A signal 104 for driving the first blue LED B1 is a pulse signal which initiates a light-up operation at a time t₃=t₁+t_{R}+t_{G} and has a frequency of f=f₀/2, an amplitude of 2·IB, and a light-up duty of t_{B}/(2·T₀). Signals 101, 103, and 105 for driving the second red, green, and blue LEDs R2, G2, and B2 are respectively delayed by one period T₀ of the basic light-up frequency with respect to the signals 100, 102, and 104 for driving the first red, green, and blue LEDs R1, G1, and B1, respectively.

That is, within the period To for alternating R, G, and B color components, driving signals, of which the light-up timings of the first red, green, and blue LEDs R1, and G1, and B1 are alternated with the light-up timings of the second red, green, and blue LEDs R2, G2, and B2. In this case, I_{R}, I_{G}, and I_{B} denote amplitudes of signals that provide a driving current required in a light-up mode of FIG. 1.

Now, the operation of the image display apparatus 1 will be described with respect to the operation of the illumination unit 2 according to an exemplary embodiment of the present invention.

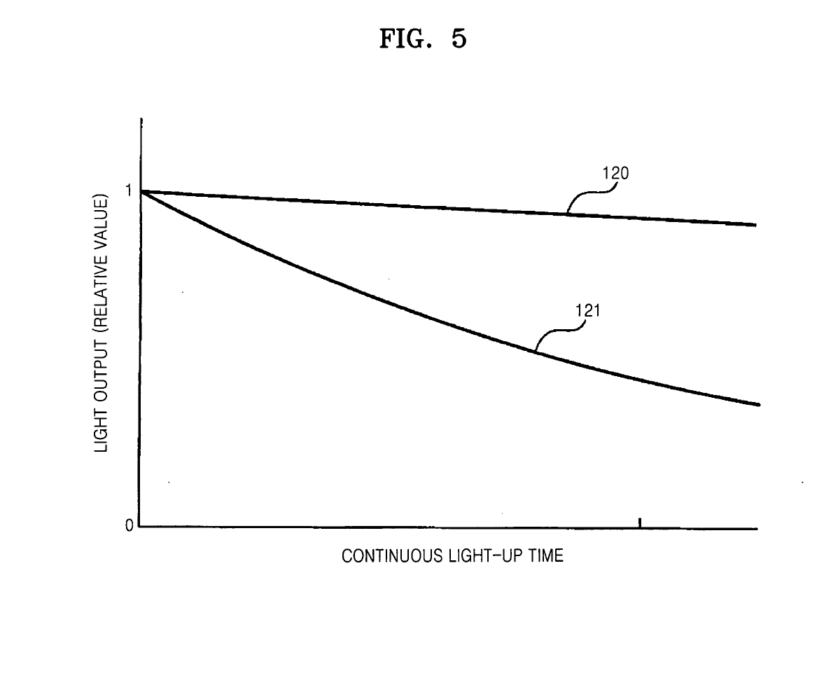

FIG. 5 is a graph illustrating a light output of an LED according to temperature. The horizontal axis denotes time, and the vertical axis denotes a relative value of light output.

As shown in FIG. 2, when an image signal having decomposed color components of R, G, and B is externally received, the controller 10 of the image display apparatus 1 transmits a light-up clock signal, which has a basic light-up frequency f₀, and sequentially lights up the R, G, and B color components, and also transmits control information that performs the function of controlling an initial light-up timing of each color to the illumination unit 2 and the spatial modulator 4.

In the illumination unit 2, the signals 100 to 105 are generated by the waveform pattern generator 23. When the signals 100 to 105 are transmitted to the LED driver circuit 21, each of the LEDs R1, R2, G1, G2, B1, and B2 included in the LED light source unit 20 is driven, and light beams having wavelengths of R, G, and B are driven in a time-sequential manner. Meanwhile, the spatial modulator 4 is driven in a time-sequential manner in substantial synchronization with a timing at which light beams having wavelengths of R, G, and B are emitted, according to the control information transmitted from the controller 10 and in response to the image signal having decomposed color components.

Accordingly, the light beams of R, G, and B emitted from the illumination unit 2 are condensed in the condenser lens 3 and are spatially modulated by the spatial modulator 4, thereby displaying a color-decomposed image corresponding to each color on the spatial modulator 4. The image displayed on the spatial modulator 4 is enlarged through the projection lens 5 and is projected onto the reflective screen 6. Since the color-decomposed image is viewed with the naked eye as having a mixed color image, an observer can view a full color image through light beams sequentially reflected from the reflective screen 6.

When a constant current is supplied, an LED has a temperature characteristic in which a light output decreases as the temperature rises. For example, as shown in FIG. 5, when the same LED is sequentially lighten up at a room temperature condition (see curve 120) and at a higher temperature condition (See curve 121), the brightness declines as time elapses as shown by the curve 121. This result is due to self heat generation and becomes significant at a substantially high temperature as a light-up time increases. Meanwhile, at room temperature, heat dissipates even when self heat generation occurs. Thus, as indicated by the curve 120, the brightness declines less steeply than the curve 121.

In the related art method, the LEDs R1 and R2, G1 and G2, B1, and B2 of FIG. 1 are substantially simultaneously lighten up in pairs. However, according to the exemplary embodiment shown in FIG. 4, the light-up time is reduced by half when respective light-up frequencies of the LEDs R1, R2, G1, G2, B1, and B2 are set to be half of the basic light-up frequency. When amplitudes of the respective driving signals are doubled, and thus the brightness of each of the LEDs R1, R2, G1, G2, B1, and B2 per the light-up time is doubled, the at least the substantially same brightness as in the related art method can be obtained.

When the brightness is approximately doubled, power consumption becomes approximately double per unit pulse. However, since the time for heat dissipation is approximately doubled, effective heat dissipation is achieved and thermal storage quantity of self heat generation is substantially reduced.

Accordingly, when the light-up operation continues for a long period of time, the temperature increase is substantially reduced and the lifespan of LED may be substantially extended in comparison with the related art method of FIG. 1. In addition, brightness degradation caused by the temperature increase is substantially reduced.

Now, an image display apparatus 50 will be described according to another exemplary embodiment of the present invention.

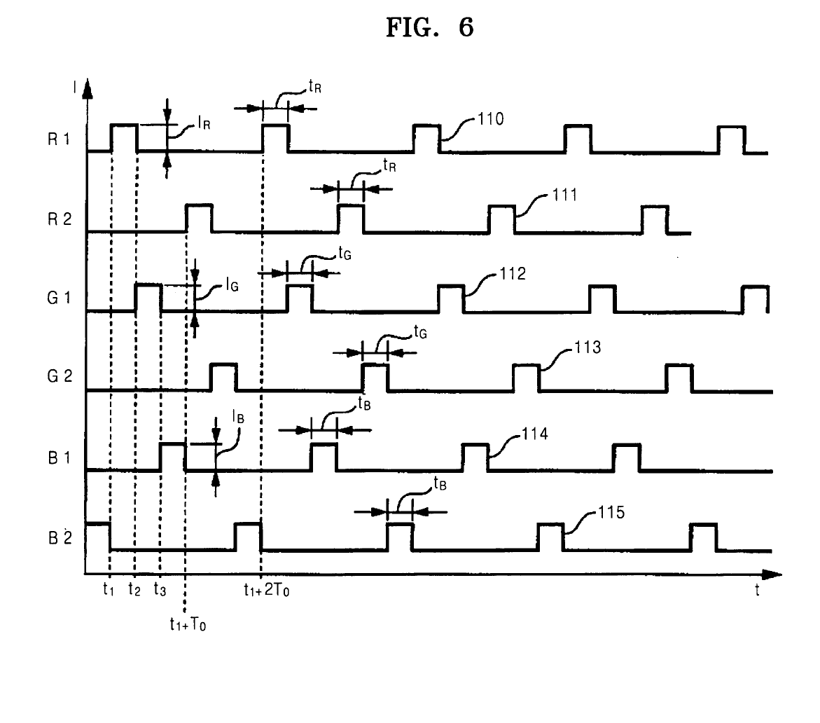

FIG. 6 is a timing chart illustrating a driving signal of a light source unit, wherein the driving signal is generated by a light controller of the image display apparatus according to another exemplary embodiment of the present invention.

As shown in FIGS. 2 and 3, image display apparatus 50 includes an illumination unit 60 instead of the illumination unit 2.

Instead of the waveform pattern generator 23, the illumination unit 60 includes a waveform pattern generator 27. Further, a temperature detector 25 and a light-up mode selector 26 (see the double-dashed line) are additionally provided. The following descriptions will focus on the differences from the image display apparatus 1, for the sake of clarity and precision.

In the waveform generator 27, a simultaneous light-up mode and a dispersed light-up mode can be alternated. In the simultaneous mode, driving signals corresponding to signals 200 to 205 of FIG. 1 are generated. In the dispersed light-up mode, signals 110 to 115 of FIG. 6 are generated.

The reference numerals 110, 112, and 114 denote signals for driving the first red, green, and blue LEDs R1, G1, and B1. These signals are driving signals having signal periods of 2·T₀ indicated by the reference numerals 200, 202, and 204 of FIG. 1. In addition, the reference numerals 111, 113, and 115 are signals for driving the second red, green, and blue LEDs. These signals are obtained by respectively delaying the signals 110, 112, and 114 for driving the red, green, and blue LEDs R1, G1, and B1 by a time T₀.

That is, the signals 110 to 115 for driving the LEDs R1, R2, G1, G2, B1, and B2 are driving signals having half the amplitudes of the signals 100 to 105 of the previous exemplary embodiment.

The temperature detector 25 detects the temperatures of the respective LEDs R1, R2, G1, G2, B1, and B2, and transmits a detection signal to the light-up mode selector 26. In the present exemplary embodiment, the temperatures of the LEDs R1, R2, G1, G2, B1, and B2 are indirectly detected by employing a base member 20a having a substantially high thermal conductivity and a temperature sensor in contact with the base member 20a or embedded in the base member 20a. The type of the temperature sensor is not particularly limited, and thus any suitable temperature sensor may be used as necessary.

Moreover, when the base member 20a has an inconstant temperature distribution due to its own configuration and material, temperature sensors may be disposed near the respective LEDs R1, R2, G1, G2, B1, and B2 to detect the temperatures of the respective LEDs R1, R2, G1, G2, B1, and B2.

When the temperature corresponding to the detection signal transmitted from the temperature detector 25 is below a threshold value, the light-up mode selector 26 transmits a control signal for setting a simultaneous light-up mode to the waveform pattern generator 27. On the contrary, when the temperature exceeds the threshold value, the control signal for setting a dispersed light-up mode is transmitted to the waveform pattern generator 27.

The threshold value may be set to a permissible level for brightness degradation according to a temperature condition obtained, for example, through a preliminary experiment.

in addition, when the temperature detector 25 detects the temperatures of the respective LEDs R1, R2, G1, G2, B1, and B2, it is possible to detect the temperatures of the respective LEDs R1, R2, G1, G2, B1, and B2 separately. Therefore, the threshold value may be set to a minimum threshold value according to the temperature characteristics of the LEDs R1, R2, G1, G2, B1, and B2.

Now, the operation of the image display apparatus 50 will be described with respect to the LED light source unit 20.

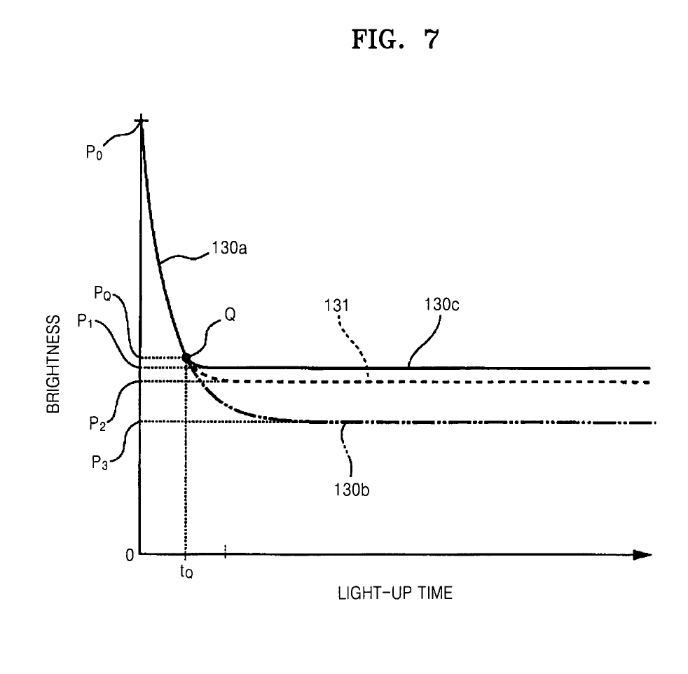

FIG. 7 is a graph illustrating brightness changes during the operation of the image display apparatus 50. The horizontal axis denotes a light-up time and the vertical axis denotes a relative brightness.

In the present exemplary embodiment, the temperature of each LED is monitored by the temperature detector 25 detecting the temperature of the base member 20a. Further, the simultaneous light-up mode and the dispersed light-up mode are selectively set by the light-up mode selector 26 in response to a detection signal.

When operation begins, an initial temperature increase due to the self heat generation of the LED light source unit 20 does not occur. Therefore, the detection temperature may not exceed the threshold value, and the operation is driven in the simultaneous light-up mode. That is, the operation is driven by the signals 200 to 205 of FIG. 1.

When the simultaneous light-up mode is continued, the temperature of the LED light source unit 20 increases due to the repeated light-up operation. Therefore, luminance brightness for a driving current decreases according to the respective temperature characteristics shown in FIG. 5. For example, as indicated by the curve 130a in FIG. 7, brightness declines to an initial value P₀ over a light-up time as time elapses.

When the simultaneous light-up mode is continued, as indicated by the curve 130b (see the double-dashed line), brightness further declines, and thus the LED light source unit 20 reaches a temperature equilibrium state. Accordingly, the brightness is in an equilibrium state at a value P₃.

Meanwhile, in the simultaneous light-up mode, if the number of times of lighting up the LEDs is reduced by half for each color, the initial value of brightness becomes ½ P₀ in substantial proportion to the number of times of lighting up. Thereafter, brightness degradation occurs in the substantially same manner as described above. Since the quantity of heat generation is also reduced by half, brightness declines further smoothly. When in the temperature equilibrium state, brightness may remain at a value higher than P₃ depending on the operational environment.

Accordingly, after the LEDs are lighted up for a long period, high brightness can be consequently achieved when one LED of each color is transited between on and off positions, instead of operating two LEDs in the simultaneous light-up mode.

In the dispersed light-up mode of FIG. 6, the first red, green, and blue LEDs R1, G1, and B1 and the second red, green, and blue LEDs R2, G2, and B2 are alternately lighted up within one period T₀ of an RGB light-up operation. Therefore, when the number of times of the light-up operation is counted, it can be seen that the number of times of the light-up operation for the LEDs is reduced by about half within one period of a basic light-up frequency. However, since the light-up frequency of each LED is f₀/2, a temporal light-up load is reduced by about half for each LED in comparison with the case of lighting only one LED. Therefore, in the dispersed light-up mode of the present exemplary embodiment, a heat dissipation time may be double compared to the case when one LED is lighted up at a frequency f₀. Accordingly, the self heat generation of each LED is significantly less accumulated.

Consequently, when the alternating light-up operation is carried out as described in the present exemplary embodiment, brightness is substantially less degraded than when the number of times of lighting up is reduced by half.

For example but not by way of limitation, when a temperature detected by the temperature detector 25 at a time t_{Q} exceeds the threshold value, and the simultaneous light-up mode is changed to the dispersed light-up mode by the light-up mode selector 26, changes occurs as indicated by the curve 130c. As an exemplary comparison, brightness changes occurring when the number of times of light-up is reduced by about half, as indicated by the curve 131.

That is, from a brightness P_{Q} at the end of the curve 130a, brightness further smoothly declines in comparison with the curve 130a. However, as indicated by the curve 130c, when in the dispersed light-up mode, the temperature equilibrium state is achieved when brightness is substantially less degraded than in the exemplary comparison case. Therefore, brightness reaches P₁ and P₂ (here, P_{Q}>P₁>P₂>P₃).

Accordingly, by switching from the simultaneous light-up mode to the dispersed light-up mode, brightness degradation may be reduced in comparison with the case when the simultaneous light-up mode is continued.

In addition, when the light-up modes are controlled to be switched, the temperature increase of each LED may be generally restricted, thereby avoiding a reduced lifespan caused by the temperature rising.

As described above, in the image display apparatus 50, the light-up controller includes a temperature detector, which detects the temperature of the LED having at least one wavelength, and a light-up mode selector, which selectively switches the simultaneous light-up mode, and n LEDs having at least one wavelength are simultaneously lighten up, and the dispersed light-up mode in which n LEDs having at least one wavelength are divided into m light-up groups to be alternately lighten up. Further, the simultaneous light-up mode and the dispersed light-up mode are switched according to the temperature detected by the temperature detector. In addition, in the second exemplary embodiment, n LEDs are provided for the three wavelengths of R, G, and B, where n=2 and m=2.

As a result, when the temperature of LED increases in the simultaneous light-up mode, the temperature detector detects the increase of temperature and the simultaneous light-up mode is switched to the dispersed light-up mode. Therefore, the temperature increase with respect to the LEDs included in the respective light-up groups may be substantially restricted, resulting in less brightness degradation than when in the simultaneous light-up mode.

Although it has been described that the driving signal of the exemplary embodiments is used for all the color components of R, G, and B, the driving signal may be used for at least one or more of those color components according to the self heat generation and the degree of interactions.

In addition, although it has been described that two LEDs having three different types of wavelengths are provided, the exemplary embodiments may be realized with two or more types of wavelengths, and the number n of the LEDs may be greater than 2.

In addition, the provided n LEDs may have at least one wavelength. For example but not by way of limitation, a required light intensity can be achieved with one LED having a wavelength excluding the at least one wavelength mentioned above. Further, when there is no concern regarding brightness degradation caused by a temperature increase or by a reduction of a temperature increase of the LED having at least one wavelength, one LED having a wavelength excluding the at least one wavelength may be used.

In addition, when the n LEDs are divided into m light-up groups, m is equal to 2 and n is equal to 2 in the image display apparatus 50. However, if n≧3, the m light-up groups may be divided by using an appropriate combination if necessary. For example, if possible, the m light-up groups may be formed by being evenly or unevenly divided by n. In the case of uneven division, the amplitude of the driving signal of LED included in each light-up group is properly set if necessary, so that luminance brightness can be adjusted within a specific time period.

In addition, although it has been described that LEDs are disposed on the base member 20a, the LEDs may be disposed on a plurality of base members if the respective LEDs are adjacent to one another to such an extent that they are affected by thermal influence.

In addition, although it has been described that the basic light-up frequency coincides with a periodical time period as an example, a timing may be provided in which a plurality of LEDs may be simultaneously lighted up within one period of the basic light-up frequency. For example but not by way of limitation, a timing may be provided in which R, G, and B color components are simultaneously lighted up to increase an apparent brightness of an image.

In addition, although it has been described that the image display apparatus displays an image onto a reflective screen, the image display apparatus may display the image by projecting light onto a transmissive screen, such as a rear projection television set. Moreover, as long as light is projected onto a display medium such as the transmissive screen, the image display apparatus may also be used as for an illumination device or a light transmission device.

In addition, the elements described in the exemplary embodiments may be suitably combined without departing from the scope of the invention if technically available.

The terms used in each exemplary embodiment and the terms used in the claims are described in light of their correspondence relations when the terms are used differently.

The LED light source unit 20 is an example of a light source unit. The LEDs R1, R2, G1, G2, B1, and B2 are examples of a light emitting element. The LED driver circuit 21 and the waveform pattern generator 23 are examples of a light-up generator. The temperature detector 25 and the light-up mode selector 26 are examples of the light-up controller, along with the LED driver circuit 21 and the waveform pattern generator 27. In the aforementioned embodiments, the LEDs having wavelengths of R, G, and B are respectively divided into two light-up groups. For example, in the case of an LED having an R wavelength, the first red LED R1 and the second red LED R2 constitute one light-up group.

The exemplary embodiments can include computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. However, the exemplary embodiments are not limited thereto. The computer readable recording medium can also be distributed over network coupled computer systems so that the computer readable code is stored and executed in a distributed fashion.

According to an image display apparatus of the present invention, n light emitting elements having at least one wavelength are divided into m light-up groups, and individual light-up frequencies of the respective light-up groups are set to 1/m, thereby reducing the temperature increase of the light emitting elements. Therefore, the lifespan of the light emitting elements may be extended while brightness degradation caused by thermal influence may be restricted.

While the present invention has been particularly shown and described with reference to exemplary embodiments thereof, it will be understood by those skilled in the art that various changes in form and details may be made therein without departing from the spirit and scope of the present as defined by the appended claims.

What is claimed is:

1. An image display apparatus comprising:
a light source which comprises a plurality of light emitting elements having substantially different wavelengths, wherein n light emitting elements have at least one wavelength and n is an integer greater than 2; and
a light-up controller which drives the light emitting elements having the substantially different wavelengths in a time-sequential manner within a time period,
wherein the light-up controller divides the n light emitting elements into m light-up groups having a substantially same light-up timing, the m light-up groups are alternately lighted up at a frequency of 1/m within the time period, so that at least one of the m light-up groups is lighted up within the time period, and m is an integer satisfying 2≦m≦n.

2. The image display apparatus of claim 1, wherein the light-up controller comprises:
a temperature detector which detects the temperature of the n light emitting elements;
a light-up mode selector which selectively changes a simultaneous light-up mode, in which the n light emitting elements are substantially simultaneously lighted up, and a dispersed light-up mode in which the n light emitting elements are divided into the m light-up groups to be alternately lighted up at different times, wherein
the light-up mode selector transits between the simultaneous light-up mode and the dispersed light-up mode according to the temperature detected by the temperature detector.

3. The image display apparatus of claim 2, wherein the light-up mode selector selects the simultaneous light-up mode if the temperature detected by the temperature detector is below a threshold value, and selects the dispersed light-up mode if the temperature detected by the temperature detector exceeds the threshold value.

4. The image display apparatus of claim 3, wherein the threshold value is a permissible level for brightness degradation of the light source.

5. The image display apparatus of claim 2, wherein:
the light source comprises a base member mounted with the light emitting element; and
the temperature detector comprises a temperature sensor disposed on the base member.

6. The image display apparatus of claim 2, wherein:
the light source comprises a base member mounted with the light emitting element; and
the temperature detector comprises a plurality of temperature sensors which are respectively adjacent to the light emitting elements and are disposed on the base member.

7. The image display apparatus of claim 1, wherein the light emitting elements are light emitting diodes (LEDs).

8. The image display apparatus of claim 2, wherein the temperature detector comprises one of a temperature sensor disposed at the light source, and a plurality of temperature sensors which are respectively adjacent to the light emitting elements and disposed at the light source.

9. A method of displaying an image, the method comprising:
driving a plurality of light emitting elements having substantially different wavelengths in a time-sequential manner within a time period; and
dividing the plurality of light emitting elements, wherein n light emitting elements have at least one wavelength, where n is an integer greater than 2, into m light-up groups having a substantially same light-up timing, wherein the m light-up groups are alternately lighted up at a frequency of 1/m within the time period, so that at least one of the m light-up groups is lighted up within the time period, and m is an integer satisfying 2≦m≦n.

10. The method of claim 9, further comprising:
detecting the temperature of the n light emitting elements; and
selectively changing a simultaneous light-up mode, in which the n light emitting elements are substantially simultaneously lighted up, and a dispersed light-up mode in which the n light emitting elements are divided into the m light-up groups to be alternately lighted up at different times, wherein transition between the simultaneous light-up mode and the dispersed light-up mode occurs according to the detected temperature.

11. The method of claim 10, further comprising:
selecting the simultaneous light-up mode if the temperature detected by the temperature detector is below a threshold value, and selecting the dispersed light-up mode if the temperature detected by the temperature detector exceeds the threshold value.

12. The method of claim 11, wherein the threshold value is a permissible level for brightness degradation of the light source.

13. The method of claim 9, wherein the light emitting elements are light emitting diodes (LEDs).

14. The method of claim 9, wherein the driving comprises driving a spatial modulator in the time-sequential manner, so as to spatially modulate the light beams of the color components.

15. A computer readable medium including a set of instructions for displaying an image, the instructions comprising the following operations:
driving a plurality of light emitting elements having substantially different wavelengths in a time-sequential manner within a time period; and
dividing the plurality of light emitting elements,
wherein n light emitting elements have at least one wavelength into m light-up groups having a substantially same light-up timing, the m light-up groups are alternately lighted up at a frequency of 1/m within the time period so that at least one of the m light-up groups is lighted up within the time period, n is an integer greater than 2 and m is an integer satisfying 2≦m≦n.

16. The computer readable medium of claim 15, further comprising:
detecting the temperature of the n light emitting elements; and
selectively changing a simultaneous light-up mode, in which the n light emitting elements are substantially simultaneously lighted up, and a dispersed light-up mode in which the n light emitting elements are divided into the m light-up groups to be alternately lighted up at different times, wherein transition between the simultaneous light-up mode and the dispersed light-up mode occurs according to the detected temperature.

17. The computer readable medium of claim 16, further comprising:
selecting the simultaneous light-up mode if the temperature detected by the temperature detector is below a threshold value, and selecting the dispersed light-up mode if the temperature detected by the temperature detector exceeds the threshold value.

18. The computer readable medium of claim 17, wherein the threshold value is a permissible level for brightness degradation of the light source.

19. The computer readable medium of claim 15, wherein the light emitting elements are light emitting diodes (LEDs).

20. The computer readable medium of claim 15, wherein the driving comprises driving a spatial modulator in the time-sequential manner, so as to spatially modulate the light beams of the color components.
